(19) United States
(12) Patent Application Publication
(10) Pub. No.: US 2002/0099462 A1
(43) Pub. Date: Jul. 25, 2002

(54) Method and apparatus for sequencing production in a manufacturing environment

(76) Inventors: F. Javier Gurrola-Gal, Doylestown, PA (US); Kedar S. Naphade, Pennington, NJ (US)

Correspondence Address: Ryan, Mason & Lewis, LLP, 1300 Post Road, Suite 205, Fairfield, CT, 06430, US

(21) Appl. No.: 09/727,219

(22) Filed: Nov. 30, 2000

(51) Int. Cl. G06F 17/60; G06F 19/00

(52) U.S. Cl. 700/100; 705/7; 700/101

(57) ABSTRACT

A method and apparatus are disclosed for sequencing the assembly and test production of products in a manufacturing environment. The disclosed production sequencer compares the composition of each order to available inventory levels to identify and prioritize the quantity of each product that must be manufactured. The present invention increases on-time deliveries, constrains the level of the finished goods inventory, referred to herein as the final output buffer (FOB), of each product to a specified maximum FOB size, and levels the load on the warehousing operation to ensure that products that are manufactured on time also get shipped on time. The present invention may be utilized in a build-to-stock environment with pull production control, in a pure assemble-to-order (ATO) environment with no finished goods inventory, or in a hybrid environment where some of the daily demand is satisfied through stock and some is satisfied through ATO.

### FIELD OF THE INVENTION

The present invention relates to the field of production and operations management, and more particularly to a method and apparatus for sequencing the assembly or production of products in a manufacturing environment.

### BACKGROUND OF THE INVENTION

In order to deliver products from a manufacturer to a customer, a number of operational stages must be coordinated, including controlling the inventory of the component parts, the production or assembly of the products, the inventory of finished products and ultimately, shipping the finished products to customers. There are a number of different operational modes that may be employed by manufacturers in order to assemble and deliver finished products in a manner that minimizes the operational costs while maximizing on-time delivery performance. For example, many manufacturers employ a build-to-stock (BTS) operational mode that establishes manufacturing levels based on a forecast of demand, while maintaining a desired level of finished goods inventory (FGI). In this manner, ordered products can generally be promptly delivered to customers from inventory. The stocking levels (finished goods inventory) for different product families are determined based on factors such as the manufacturing throughput time for a given product, the expected demand, seasonality and forecast errors.

In order to achieve significant savings in finished goods inventory, manufacturers may employ a build-to-order (BTO), an assemble-to-order (ATO), a near-BTO or near-ATO operational mode. In contrast to a BTS mode, where the product is expected to be available in finished goods inventory when a customer order is received, a BTO mode implies that all products required for an order will be produced after the customer order is received. An ATO mode implies that all products required will be assembled from subassemblies after the order is received. In a near-ATO or near-BTO mode, some of the products required for an order may be produced after the order is received and others may be shipped from existing finished goods inventory.

The manufacturing process involves using limited manufacturing resources to produce a variety of different products. The warehousing process involves picking and packing various quantities of finished products that may appear on a given order and shipping the packed order to the customer. Hence, a BTO or ATO operational mode requires efficient and streamlined order processing, and synchronization between the manufacturing process and the warehousing process so that the right products are produced at the right time enabling a high percentage of orders to be processed and shipped through the warehouse on time..

The manufacturing process must be closely coordinated with orders that are due to be shipped to customers in the very near future. The manufacturing process must also ensure that products that are manufactured and the sequence in which they are manufactured enables them to be shipped and they do not remain in finished goods inventory due to resource constraints or other operating constraints in the warehousing operation.

In many manufacturing environments, a single customer order may consist of numerous different products being ordered in different quantities. Customers demand that the whole order be shipped together, except under special circumstances. Thus, the concept of whole-order-delivery requires that all the different products required for an order must be shipped simultaneously and on time to count the order as delivered on time. If any portion of the material for the order is unavailable, then the order will generally not be shipped unless the customer or a sales representative has specifically permitted the possibility of partial shipment for the order. If an order is not shipped due to the lack of one or more finished products, the whole order delivery metric suffers. Thus, the sequence and quantities in which different products are produced or assembled in the manufacturing operation must take into account these whole order delivery requirements.

Manufacturers may also stock and sell products that are made by other suppliers or original equipment manufacturers (OEMs) (hereinafter, collectively referred to as “third party products”), in addition to the products that they manufacture themselves (hereinafter, referred to as “in-house products”). A single customer order could request some products that are in-house products and others that are third party products. Thus, under whole order delivery requirements, an order can be delayed by the unavailability of such third party products, even when the manufacturer can produce or has the requested in-house products available on time.

Thus, in order to maximize on-time delivery performance in a BTO, ATO, near-BTO or near-ATO environment, manufacturers need to employ algorithms that determine the sequence and quantities in which various products must be assembled. Such algorithms need to consider complexities such as whole order delivery, orders consisting of in-house and third party products and the ability of the warehousing staff to pick pack and ship orders that are complete. Since the basic purpose of a BTO, ATO, near-BTO or near-ATO system is to achieve significant finished goods inventory savings in addition to maintaining satisfactory on-time whole order delivery, the algorithms also need to ensure that the finished goods inventory that results from the production, is controlled or restricted to reasonable levels.

A need therefore exists for a method and apparatus for determining the quantities and sequence in which products should be produced in order to maximize on-time whole order delivery to the customer. A further need exists for a method and apparatus for determining the quantities and sequence in which products should be produced that restrict the finished goods inventory to a predetermined upper bound. Yet another need exists for a method and apparatus for determining the quantities and sequence in which products should be produced that synchronizes the warehousing and manufacturing functions to take into account any constraints in the warehousing operation so that all products that are assembled on time can also be packed into orders and shipped on time. Finally, the need exists for a method and apparatus for determining the sequence and quantities in which products should be produced that links the manufacture of in-house products to the availability of third party products.

### SUMMARY OF THE INVENTION

Generally, a method and apparatus are disclosed for determining the quantity and sequence of products to be produced or assembled in a BTO, ATO or near-ATO manufacturing environment. The disclosed production sequencer compares the composition of each order to available finished goods inventory levels to identify and prioritize the quantity of each product that must be manufactured. The present invention (i) attempts to maximize whole order delivery, (ii) considers the availability of third party products, (iii) constrains the level of the finished goods inventory, referred to herein as the final output buffer (FOB), of each product to a specified maximum FOB size, and (iv) levels the load on the warehousing operation to ensure that products that are manufactured on time also get shipped on time. The present invention improves whole order delivery performance by prioritizing the sequence in which products are built based on a view of the demand over the near future and availability of finished goods.

The present invention links the production schedule to the availability of third party products. Thus, if an order must await delivery of one or more third party products, then the products that are needed for that order will be assigned a lower priority in favor of products needed for orders that can be shipped on time.

In addition, the disclosed production sequencer balances the load on the warehousing operation to ensure that products that are manufactured on time also get shipped on time. Generally, the production sequencer assigns a higher priority to products associated with orders that will require more time to pick, pack and ship. This presents higher amounts of work for the warehouse earlier in the day, allowing the warehouse to level load the work during the day.

The level of the finished goods inventory, referred to herein as the final output buffer (FOB), of each product is constrained to a specified maximum FOB size. The determination of ideal FOB sizes is important but is outside the scope of the production sequencer. The maximum FOB size by product is an input to the production sequencer. The production sequencer guarantees that the maximum FOB size will not be exceeded for any given product. In a further variation, the disclosed production sequencer optionally allows a desired quantity of anticipation stock (often referred to as a build-ahead inventory) to also be sequenced. In this manner, the manufacturer can prepare for peak season demand that may exceed manufacturing capacity. The present invention offers advantages for a build-to-stock environment with pull production control, a pure BTO or ATO environment with no finished goods inventory, or a hybrid environment where some of the daily demand is satisfied through stock and some is satisfied through BTO or ATO.

A more complete understanding of the present invention, as well as further features and advantages of the present invention, will be obtained by reference to the following detailed description and drawings.

### BRIEF DESCRIPTION OF THE DRAWINGS

FIG. 1 illustrates a production sequencer in accordance with the present invention;

FIG. 2 illustrates a prioritized list of quantities to be manufactured for each product in accordance with the present invention;

FIG. 3 is a flow chart describing an exemplary sequencing process of FIG. 1 incorporating features of the present invention;

FIG. 4 is a flow chart describing an exemplary material shortage routine executed by the sequencing process of FIG. 3; and

FIGS. 5A and 5B, collectively, are a flow chart describing an exemplary prioritization routine executed by the sequencing process of FIG. 3.

### DETAILED DESCRIPTION

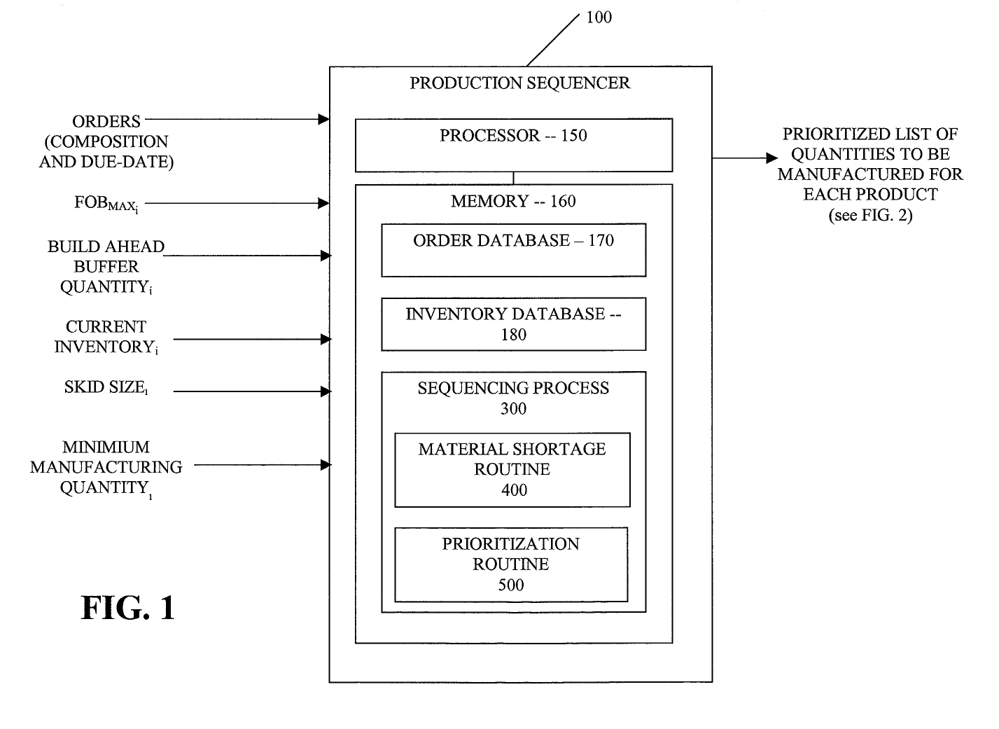

FIG. 1 illustrates a production sequencer 100 in accordance with the present invention. As shown in FIG. 1, the production sequencer 100 processes a number of inputs in order to generate a prioritized list of quantities to be manufactured for each offered product. The production sequencer 100 may be embodied as any computing device, such as a personal computer or workstation, as modified herein to carry out the features and functions of the present invention. As shown in FIG. 1, the production sequencer 100 contains a processor 150, such as a central processing unit (CPU), and memory 160, such as RAM and ROM.

The production sequencer 100 receives order information, such as the units of each product required by each order and the shipping due-date for each order, that is optionally stored in an order database 170. In addition, the current inventory levels of each product are determined and may optionally be stored in an inventory database 180. Additional parameters utilized by the production sequencer 100 include the desired maximum FOB level for each product, the build-ahead quantities, if any, the skid size or transfer batch size for each product and the minimum manufacturing size of each product. These parameter values need to be predefined for each product. As previously indicated, the production sequencer 100 processes these values to generate a prioritized list of quantities to be manufactured for each product

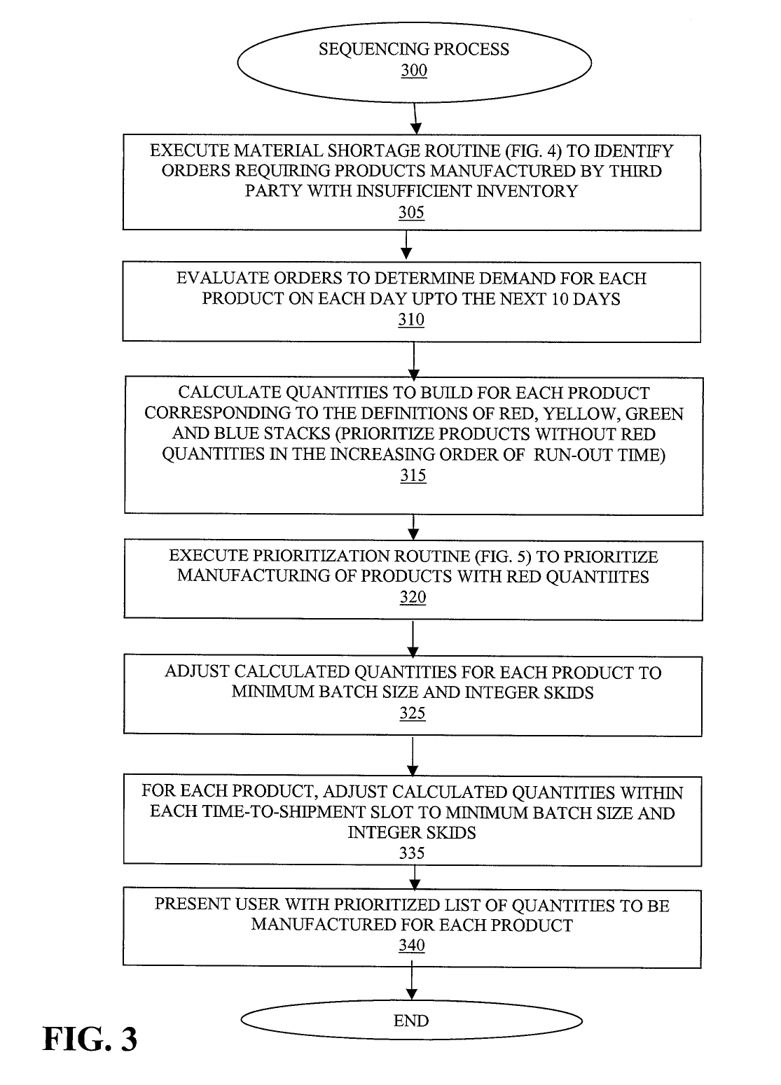

In addition, as shown in FIG. 1, and discussed further below in conjunction with FIGS. 3 through 5, respectively, the memory 160 of the production sequencer 100 contains a sequencing process 300. Embedded within (or associated with) the sequencing process is a material shortage routine 400 and a prioritization routine 500. The sequencing process 300 compares the composition of each order to available inventory levels to identify and prioritize the quantity of each product that must be manufactured.

The sequencing process 300 is typically executed once every planning period (e.g., every day) in order to determine the quantities and sequence in which products must be produced during the current and future planning periods. Generally, this planning period may be any practicable time unit such as a shift, a day or a week. Without loss of generality, for ease of discussion in the following, we assume that this planning period is a day and the sequencing process is executed at the beginning of the day.

The sequencing process 300 executes the material shortage routine 400 to identify those orders that will not be shipped today due to shortages of third party products and to assign a lower priority to quantities on those orders. This ensures that scarce manufacturing resources are focussed on products that have a high likelihood of being shipped today. The sequencing process 300 executes the prioritization routine 500 to prioritize among the different products that must be produced.

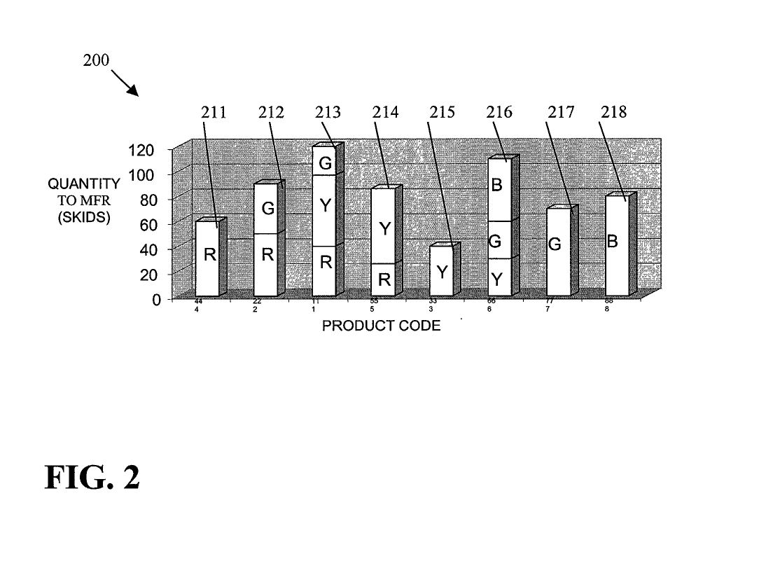

In one illustrative embodiment, the production sequencer 100 generates a chart 200, shown in FIG. 2. The exemplary chart 200 utilizes a bar graph with each product, such as the bars 211-218, each corresponding to a different product. The height of each bar 211-218 corresponds to the quantity of the corresponding product that must be manufactured. In addition, the bars 211-218 are prioritized from left to right, indicating the preferred order in which the products should be manufactured. In the illustrative embodiment, each bar may be comprised of stacks of four different colors, such as red (R), yellow (Y), green (G), and blue (B). The quantities in red indicate the number of products that are to be shipped in a first time-to-shipment slot, such as today, with insufficient on-hand inventory to meet today's demand. The quantities in yellow indicate the number of products that are to be shipped in a second time-to-shipment slot, such as within the next four days. The quantities in green indicate the number of products associated with a third time-to-shipment slot, such as those that do not have any demand over the first five days and are built purely to replenish the FOB. Finally, the quantities in blue indicate the number of products that are associated with a fourth time-to-shipment slot, such as are those that do not have any demand over the next five days but must be built to prepare build-ahead buffers for anticipated peak season demand over capacity. All the quantities are presented in the chart 200, for example, in units of skids.

According to a further feature of the invention, the production sequencer 100 provides a real-time progress tracking feature. As skids of products are manufactured, they will be scanned into the database of the production sequencer 100 at the end of the production line. This will enable the production sequencer 100 to show a progress bar that advances from the bottom to the top in the center of each bar in the output chart 200. Thus, the production sequencer 100 will continue to tell the manufacturing line, “what to do next,” throughout the day. This also provides a very useful tool for management to assess the day's progress by one glance at the chart 200 and shift priorities, when necessary, if some important orders need to be shipped earlier.

Through a calculation of the height of the stacks based on on-hand inventory and demand, the production sequencer 100 guarantees that the FOB size plus the build ahead buffer size restriction will not be violated. In other words, the production sequencer 100 guarantees that the current on-hand inventory plus the total height of all stacks for a product (maximum production of the product today) less the total demand to be shipped today does not exceed the FOB size plus the build-ahead buffer.

To utilize the chart 200 generated by the production sequencer 100, to control daily production in the final assembly and test shop, the following general operating guidelines should be followed:

1. The production line should first work on the red stacks, then on the yellow stacks, then on the green stacks and then on the blue stacks.

2. Within each color, the line should work on codes from left to right.

3. The line should not build more than the total height of the red, yellow, green and blue stacks for any code.

4. If there is capacity, all the red stacks should be built and transferred to the warehouse by a certain time, to permit the orders to be packed and shipped.

### The Sequencing Process 300

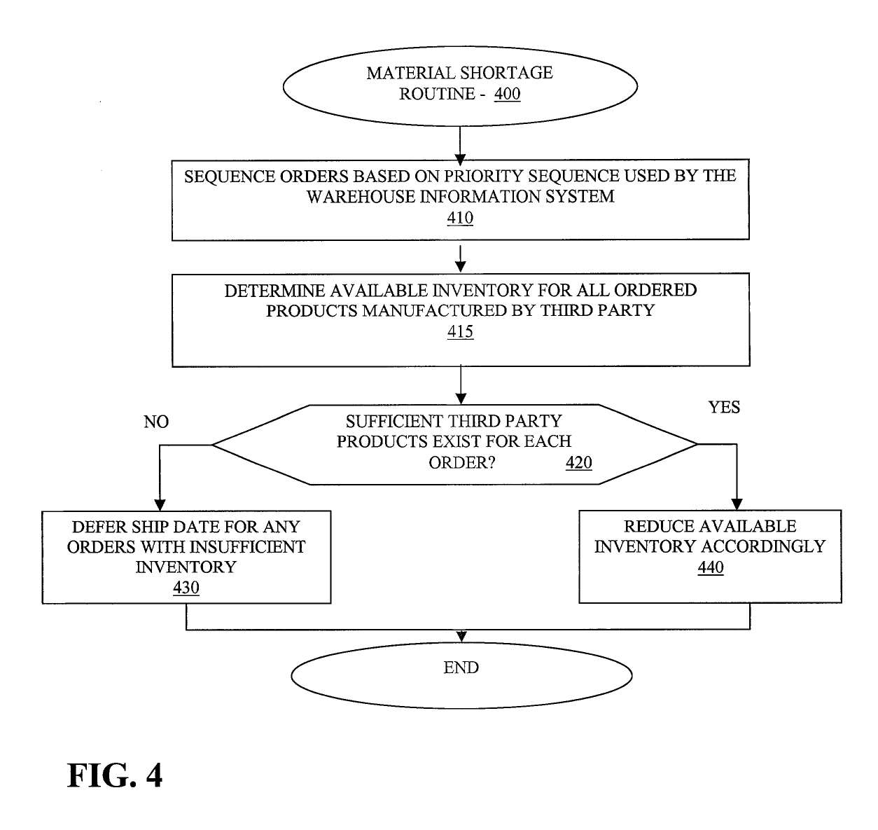

As previously indicated, the production sequencer 100 executes the sequencing process 300, shown in FIG. 3, that compares the composition of each order to available inventory levels to identify and prioritize the quantity of each product that must be manufactured. As shown in FIG. 3, the sequencing process 300 initially executes the material shortage routine 400, discussed below in conjunction with FIG. 4, during step 305 to identify orders having third party products with insufficient inventory. The material shortage routine 400 assigns a lower priority to quantities that may not ship today due to third party shortages. Thereafter, the sequencing process 300 evaluates orders to determine the demand for each product during step 310, for example, for each day in the next 10 day period.

Thereafter, the sequencing process 300 calculates the quantities to build for each product during step 315, based on the composition of each order, available inventory levels and maximum FOB levels. Exemplary pseudocode for step 315 is discussed below. During step 315, the sequencing process 300 also calculates the illustrative red, yellow, green and blue quantities that add up to the total quantity of product to be built. Further, the sequencing process 300 prioritizes among products without any red quantities based on run-out time. The run-out time is the number of days for which the current on-hand inventory of a product will satisfy demand from orders. In other words, products with finished goods inventory levels that will run out in a smaller amount of days are given higher priority for production.

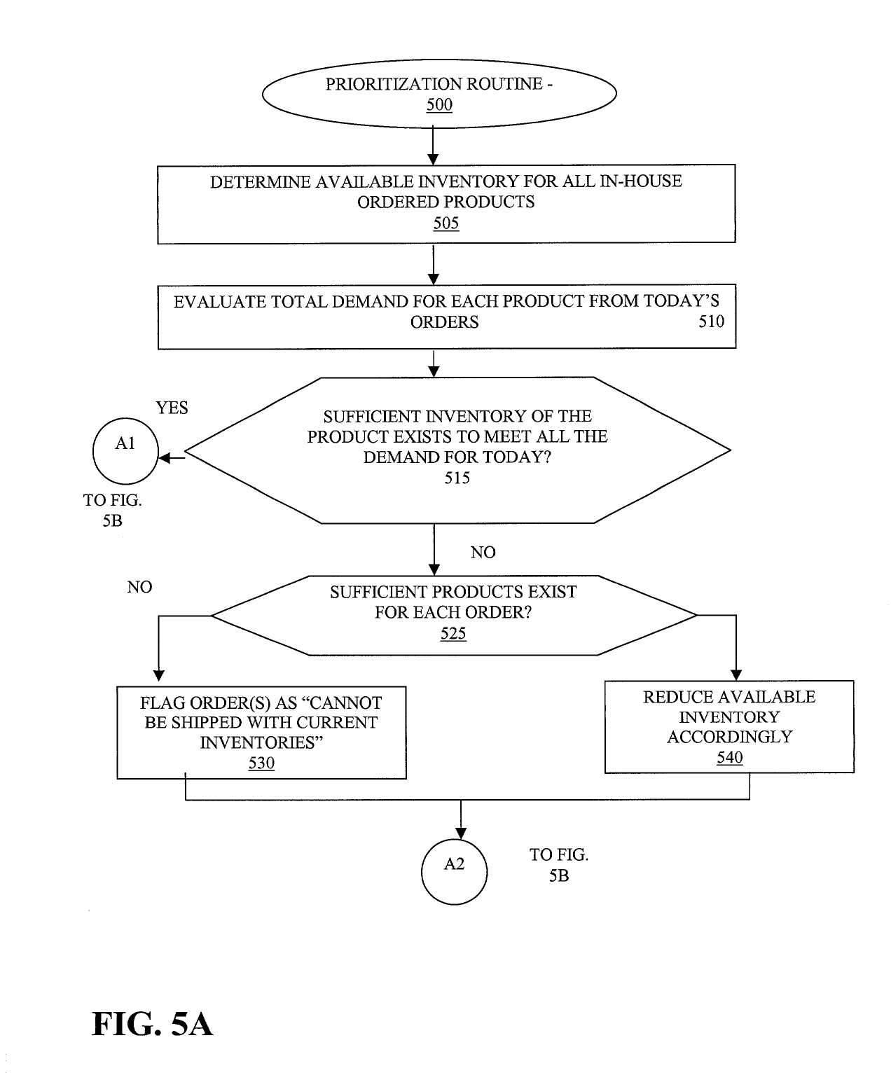

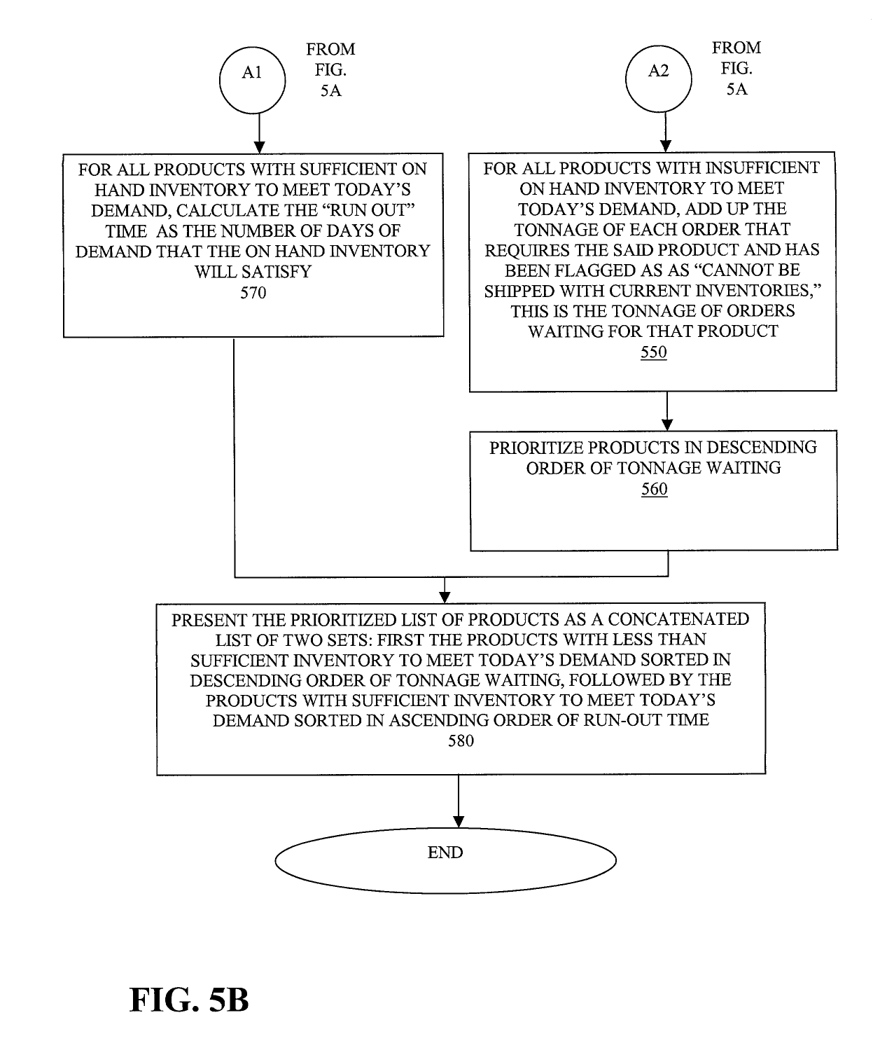

The prioritization routine 500, discussed below in conjunction with FIGS. 5A and 5B, is then executed during step 320 to prioritize only the manufacturing of products with red quantities.

The calculated quantities for each product are then adjusted to the corresponding minimum batch size and an integer number of skids or pallets during step 325. For each product, the calculated quantities are adjusted within each time-to-shipment slot to the minimum size during step 335. Finally, the user is presented with the prioritized list of quantities to be manufactured per the exemplary illustration in FIG. 2 for each product during step 340, before program control terminates.

Exemplary Pseudocode for Step 315

N: Total number of In house products
F(i): Maximum FOB Size for product i.
BA(i): Build Ahead Inventory Level for product i.
Q(i): Current on hand inventory level for product i.
D(i,t): Demand for product i on day t. This is calculated in step 310 taking into account
orders that will not ship today (on day 0) based on the material prioritization routine 400.
‘Generate Workbox for all codes i = 1 to N
i = 0
Do While (i < N)

i = i + 1
‘Initialize
Red(i) = 0
Yellow(i) = 0
Green(i) = 0
Blue(i) = 0
P(i) = 1000000
‘Calculate total demand for code for 10 days starting today
Tot_demand(i) = 0
For t = 0 To 9

Tot_demand(i) = Tot_demand(i) + D(i, t)

Next t
‘Calculate total demand for code for 5 days starting today
Five_day_demand(i) = 0
For t = 0 To 4

Five_day_demand(i) = Five_day_demand(i) + D(i, t)

Next t
If (Q(i) < D(i, 0)) Then

Red(i) = D(i, 0) − Q(i) ‘Calculate the size of the red bar if one is necessary

Else

‘Calculate the Priority for Codes with no Red
‘Here the Priority is the life of the inventory on hand or the run-out time
Cum_Demand = D(i, 0)
ExitFlag = 0
t = 0
Do While (t < 9 And ExitFlag = 0)

t = t + 1
Cum_Demand = Cum_Demand + D(i, t)

If (Q(i) < Cum_Demand) Then

P(i) = t − 1 + (Q(i) − Cum_Demand + D(i, t)) / D(i, t)
ExitFlag = 1

End If

Loop
‘Calculate the priority if the life of on hand inventory is
‘more than 10 days
If (Tot_demand(i) > 0 And P(i) = 1000000) Then

P(i) = Q(i) * 10 / Tot_demand(i)

End If

End If
‘Calculate the Yellow bar if it should exist
If (P(i) <= 4) Then

Yellow(i) = Five_day_demand(i)
Yellow(i) = Yellow(i) − Red(i) − Q(i)
If (Yellow(i) + Red(i) + Q(i) − D(i, 0) > F(i)) Then

Yellow(i) = F(i) − Red(i) − Q(i) + D(i, 0)

End If
If Yellow(i) < 0 Then Yellow(i) = 0

End If
‘Calculate the Green Bar
Green(i) = F(i) − Q(i) − Red(i) − Yellow(i) + D(i, 0)
If (Green(i) < 0) Then Green(i) = 0
‘Calculate the Blue Bar
If BA(i) = 0 Then

Blue(i) = 0

Else

Blue(i) = F(i) + BA(i) − Q(i) − Red(i) − Yellow(i) − Green(i) + D(i, 0)

End If
If (Blue(i) < 0) Then Blue(i) = 0
If(P(i) = 1000000) Then

If (Green(i) > 0) Then

P(i) = 1000000 − Green(i)

ElseIf (Blue(i) > 0) Then

P(i) = 10000000 − Blue(i)

Else

P(i) = 1000000000

End If
End If
If (Red(i) + Green(i) + Yellow(i) + Blue(i) = 0) Then P(i) = 1000000000

Loop

At the end of the above routine, the red, yellow, blue and red quantities for each code are determined in accordance with the definitions provided. The method guarantees that the FOB size, F, and build ahead quantities, BA, are not exceeded for any code. For all codes that do not have any red quantities, the priority index is calculated as the run-out time. A high P(i) implies a low priority. All red codes get a higher priority than codes without red. As previously indicated, prioritization among red codes is done in step 320 which calls the material prioritization routine 500.

### The Material Shortage Routine 400

As previously indicated, the sequencing process 300 executes the material shortage routine 400, shown in FIG. 4, to identify those orders that will not be shipped today due to shortages of third party products and to assign a lower priority to products that are required by those orders. As shown in FIG. 4, the material shortage routine 400 initially sequences the orders based on the arbitrary sequence employed by the warehouse information system during step 410. The rationale here is as follows: A Warehouse Information System (referred to hereinafter as WIS) is generally executed several times a day to compare the on-hand finished goods inventory with the composition of orders to be shipped by the end of the current day. The WIS processes these orders in a predefined arbitrary sequence. For a given order in the sequence, the WIS checks whether all material required is available in the warehouse. If all the material is indeed available in the warehouse, the WIS allocates the material to the order, thereby deducting the material from materials available to fill subsequent orders and generates an instruction to the warehouse personnel to pick, pack and ship that order. If, on the other hand, one or more products required for that order are not available, the WIS does not allocate the material to the order and skips to the next order in the sequence. Hence, given a fixed amount of inventory available of each product, and a set of orders that are competing for that inventory, the WIS uses an arbitrary predefined sequence (e.g., based on the order number) as described above to decide which orders will be shipped and which orders will wait for more inventory to become available.

Thus, in order to determine which orders will be affected by shortages of third party materials, the material shortage routine 400 must simulate the logic of the WIS and hence first sequence orders in the same sequence that will be employed by the WIS.

Thereafter, the material shortage routine 400 determines the available inventory for all ordered products manufactured by third parties during step 415. A test is performed during step 420 to determine if there are sufficient third party products for each order. If it is determined during step 420 that there are not sufficient third party products for certain orders, then the ship date is deferred during step 430 for any orders with insufficient inventory. If, however, it is determined during step 420 that there is sufficient third party products for certain orders, then the available inventory is reduced accordingly during step 440, before program control is passed on to the next order in the sequence.

At the end of the material shortage routine 400, the due dates for orders that are short of third party products are now deferred to the next day. Note that this is only within the production sequencer 100 and that none of the information in the WIS is changed.

### Pseudocode for Material Shortage Routine 400

The objective of the following routine is to identify from all orders that are due on the current day, those that will not ship due to non-availability of third party materials. For all such orders, the due date is postponed to the next day. As a result, in step 310, when the demand for each product by day is computed, today's demand for any product does not include demand from orders that cannot be shipped today due to material shortages from 3^{rd} party materials.

N: Number of 3rd party materials
O: Number of Orders due today
bom(i,j): Quantity of third party material i required by Order j.
Q(i): On hand inventory of third party material i.
Initialize dummy variable to current on hand quantity for each third party
material code, i
For i = 1 To N

dummy(i) = Q(i)

Next i
Flag all orders that will not ship today due to material shortages of third
party materials

| | |
|---|---|
| Forj = 1 To O | {Orders 1 to O are arranged in sequence to be used |
| | by the WIS to allocate material} |
| Flag(j) = 0 | {flag = 0 means the order will be shipped from |
| | on hand quantities} |
| | (flag = 1 means the order will not be shipped today |
| | due to Third Party materials not being available) |

i = 0
Do While (i < N And Flag(j) = 0)

i = i + 1
If bom(i, j) > dummy(i) Then Flag(j) = 1

Loop
If (Flag(j) = 0) Then

For i = 1 To N

dummy(i) = dummy(i) − bom(i, j)

Next i

End If

Next j

The array flag(j) is passed to step 310, where the due date for

all orders j with Flag(j) = 1 is postponed to tomorrow.

### The Prioritization Routine 500

As previously indicated, the sequencing process 300 executes the prioritization routine 500, shown in FIGS. 5A and 5B, to prioritize among the different products with red quantities that must be produced. The prioritization routine 500 partitions all the products with red quantities into two sets in steps 505 and 510. The first set of products are those that do not have enough inventory in the finished goods warehouse to meet demand from orders that are due by the end of the current day. These products are given higher priority than the second set of products, which have enough finished goods inventory to satisfy the demand from all orders to be shipped by the end of the current day.

Thus, a test is performed during step 515 to determine if sufficient inventory exists for the product to meet all the demand for the current day. If it is determined during step 515 that sufficient inventory exists for the product to meet all the demand for the current day, then program control proceeds to step 570, discussed below in conjunction with FIG. 5B. If, however, it is determined during step 515 that sufficient inventory does not exist for the product to meet all the demand for the current day, then the exemplary prioritization routine 500 determines the orders that are waiting for a specific product, adds up the tonnage of all the orders waiting for that product and prioritizes manufacturing of the product by “most tonnage waiting.” This is achieved by steps 520 through 560.

The first set of products is a critical set in that if the required quantities are not manufactured and shipped out today, customer orders will certainly be delayed. Prioritizing the production of those quantities in the sequence of “most tonnage waiting” ensures that products with high tonnage waiting are manufactured and enter the warehouse earlier in the day. Hence, the WIS will generate higher amounts of work for the warehouse personnel earlier in the day than later-enabling the warehouse to be level loaded during the day and increasing the possibility that everything that is manufactured for shipment today is indeed shipped today by the warehouse. On the contrary, if, for example, the exact reverse prioritization scheme is employed, the warehouse personnel will not see a lot of work during the day and large amounts of work will drop in at the end of the day making it impossible to finish that day and hence delaying customer orders.

For products in the first set, i.e., those products that do not have sufficient on hand inventory to meet today's demand, the prioritization routine 500 initially sequences the orders in the most current time-to-shipment slot (e.g., those orders to be shipped today) during step 520 based on the arbitrary predefined sequence employed by the WIS. A test is performed during step 525 to determine if there is a sufficient inventory of in-house products for each order. If it is determined that there is not sufficient inventory of in-house products for one or more orders, then such order(s) are flagged as “cannot be shipped with current inventories” during step 530. If, however, it is determined during step 520 that there is sufficient inventory of in-house products for one or more orders, then the available inventory is reduced accordingly during step 540 before program control is passed on to the next order. If all orders have been exhausted, program control is passed on to the next step 550 (FIG. 5B).

In step 550, for all products in the first set, the prioritization routine identifies the orders that require these products and have been flagged during step 530 as “cannot be shipped with current inventories”. The tonnage of each such order is added up to represent the total tonnage waiting for the product. The products are then prioritized in descending order of tonnage waiting during step 560. Finally, all products in the second set are prioritized in ascending order of run-out time during step 570.

Pseudocode for Prioritization Routine 500

O: Number of orders that need to be delivered today that will not be
delayed due to material shortages of third party materials.
R: Number of products that have non-zero red stacks.
Q(i): On hand inventory level of product i.
bom(i,j): Quantity of product i required by order j.
Tonnage(j): Total tonnage of Order j.
‘Initialize the dummy variable to the current on hand quantity for each
red code
For i = 1 To R

dummy(i) = Q(i)

Next i
‘Figure out which orders are going to be shipped, and which ones are
going to ‘wait for the red codes to be finished
For j = 1 To O (Arranged in the sequence used by the WIS to
fulfill orders)

Flag(j) = 0 ‘flag = 0 means the order will be shipped from on hand
quantities

‘flag = 1 means the order will wait for the one or more red
codes

‘Check if ALL the products necessary for the order are still
available

‘If not, assign flag to 1
i = 0
Do While (i < R And Flag(j) = 0)

i = i + 1
If bom(i, j) > dummy(i) Then Flag(j) = 1

Loop
‘If flag is zero decrement the dummy variable by the amount that the
‘order consumed
If (Flag(j) = 0) Then

For i = 1 To R

dummy(i) = dummy(i) − bom(i, j)

Next i

End If

Next j

At the end of the above loop, we now know which orders (flag(j)=1) will wait for the red codes to be manufactured. The next loop sums for each code, the tonnage of orders that are waiting. The higher the tonnage, lower is the P(i) and hence higher the priority of that code.

For i = 1 To R

Tons_Waiting(i) = 0
For j = 1 To O

If (Flag(j) = 1 And bom(i, j) > 0) Then

Tons_Waiting(i) = Tons_Waiting(i) + Tonnage(j)

End If

Next j
P(i) = −Tons_Waiting(i)

Next i

It is to be understood that the embodiments and variations shown and described herein are merely illustrative of the principles of this invention and that various modifications may be implemented by those skilled in the art without departing from the scope and spirit of the invention. For instance, the criterion of most tonnage waiting has been employed in the above embodiment is just exemplary in that it reflects the work content for a warehouse. The spirit of the invention is to set manufacturing priorities based on such considerations to enable synchronized and successful execution of ATO/BTO manufacturing and warehousing to deliver whole orders to customers on time.

We claim:

1. A method for sequencing production of products for one or more orders in a manufacturing environment, comprising the steps of:
evaluating each of said orders to determine a demand for each of said products;
comparing said demand for each of said products to a corresponding available inventory level to determine a quantity of each of said products that must be manufactured; and
sequencing the production of said quantity of each of said products that must be manufactured such that whole orders can be shipped on time.

2. The method of claim 1, wherein said sequencing step further comprises the step of shipping a maximum number of said whole orders on time.

3. A method for sequencing production of products for one or more orders in a manufacturing environment, wherein at least one of said orders includes a request for a third party product, said method comprising the steps of:
evaluating each of said orders to determine a demand for each of said products;
comparing said demand for each of said products to a corresponding available inventory level to determine a quantity of each of said products that must be manufactured; and
sequencing the production of said quantity of each of said products that must be manufactured based on an availability of such third party products.

4. The method of claim 3, wherein said sequencing step further comprises the step of assigning a lower priority to an order with one or more insufficient third party products.

5. A method for sequencing production of products for one or more orders in a manufacturing environment, said method comprising the steps of:
evaluating each of said orders to determine a demand for each of said products;
comparing said demand for each of said products to a corresponding available inventory level to determine a quantity of each of said products that must be manufactured; and
sequencing the production of said quantity of each of said products that must be manufactured based on processing time required to complete said one or more orders after said products are assembled.

6. The method of claim 5, wherein a tonnage waiting parameter represents said processing time required to pick, pack and ship said one or more orders after said products are assembled.

7. The method of claim 5, wherein an order is complete when it has been picked, packed and shipped.

8. The method of claim 5, wherein said sequencing step further comprises the step of assigning a higher priority to products associated with orders that will require more time to assemble, pack and ship when on hand inventory is not sufficient to meet demand for the current time interval.

9. The method of claim 5, wherein said sequencing step further comprises the step of assigning priorities to products based on a run-out time when on hand inventory is sufficient to meet demand for the current time interval.

10. A method for sequencing production of products for one or more orders in a manufacturing environment, said method comprising the steps of:
evaluating each of said orders to determine a demand for each of said products;
comparing said demand for each of said products to a corresponding available inventory level to determine a quantity of each of said products that must be manufactured, wherein said quantity of each of said products is constrained by a specified maximum final output buffer (FOB) size; and
sequencing the production of said quantity of each of said products that must be manufactured.

11. The method of claim 10, wherein said maximum final output buffer (FOB) size includes a desired quantity of anticipation stock.

12. A system for sequencing production of products for one or more orders in a manufacturing environment, comprising:
a memory that stores computer-readable code; and
a processor operatively coupled to said memory, said processor configured to implement said computer-readable code, said computer-readable code configured to:
evaluate each of said orders to determine a demand for each of said products;
compare said demand for each of said products to a corresponding available inventory level to determine a quantity of each of said products that must be manufactured; and
sequence the production of said quantity of each of said products that must be manufactured such that whole orders can be shipped on time.

13. The system of claim 12, wherein said processor is further configured to ship a maximum number of said whole orders on time.

14. A system for sequencing production of products for one or more orders in a manufacturing environment, wherein at least one of said orders includes a request for a third party product, said system comprising:
a memory that stores computer-readable code; and
a processor operatively coupled to said memory, said processor configured to implement said computer-readable code, said computer-readable code configured to:
evaluate each of said orders to determine a demand for each of said products;
compare said demand for each of said products to a corresponding available inventory level to determine a quantity of each of said products that must be manufactured; and
sequence the production of said quantity of each of said products that must be manufactured based on an availability of such third party products.

15. The system of claim 14, wherein said processor is further configured to assign a lower priority to an order with one or more insufficient third party products.

16. A system for sequencing production of products for one or more orders in a manufacturing environment, said system comprising:
a memory that stores computer-readable code; and
a processor operatively coupled to said memory, said processor configured to implement said computer-readable code, said computer-readable code configured to:
evaluate each of said orders to determine a demand for each of said products;
compare said demand for each of said products to a corresponding available inventory level to determine a quantity of each of said products that must be manufactured; and
sequence the production of said quantity of each of said products that must be manufactured based on processing time required to complete said one or more orders after said products are assembled.

17. The system of claim 16, wherein a tonnage waiting parameter represents said processing time required to pick, pack and ship said one or more orders after said products are assembled.

18. The system of claim 16, wherein an order is complete when it has been picked, packed and shipped.

19. The system of claim 16, wherein said processor is further configured to assign a higher priority to products associated with orders that will require more time to assemble, pack and ship when on hand inventory is not sufficient to meet demand for the current time interval.

20. The system of claim 16, wherein said processor is further configured to assign priorities to products based on a run-out time when on hand inventory is sufficient to meet demand for the current time interval.

21. A system for sequencing production of products for one or more orders in a manufacturing environment, said system comprising:
a memory that stores computer-readable code; and
a processor operatively coupled to said memory, said processor configured to implement said computer-readable code, said computer-readable code configured to:
evaluate each of said orders to determine a demand for each of said products;
compare said demand for each of said products to a corresponding available inventory level to determine a quantity of each of said products that must be manufactured, wherein said quantity of each of said products is constrained by a specified maximum final output buffer (FOB) size; and
sequence the production of said quantity of each of said products that must be manufactured.

22. The system of claim 21, wherein said maximum final output buffer (FOB) size includes a desired quantity of anticipation stock.
